(19) United States
(12) Patent Application Publication
(10) Pub. No.: US 2024/0422021 A1
(43) Pub. Date: Dec. 19, 2024

(54) METHOD AND APPARATUS FOR SEMI-STATIC HARQ-ACK CODEBOOK DETERMINATION FOR MULTICAST

(71) Applicant: LENOVO (BEIJING) LIMITED, Beijing (CN)

(72) Inventor: Haipeng Lei, Beijing (CN)

(21) Appl. No.: 18/703,483

(22) PCT Filed: Jan. 10, 2022
(86) PCT No.: PCT/CN2022/071072

§ 371 Date: Apr. 22, 2024

(51) Int. Cl. H04L 12/18; H04L 1/1812; H04L 1/1829; H04L 5/00

(52) U.S. Cl. CPC H04L 12/1868; H04L 1/1854; H04L 5/0055; H04L 1/1812

(57) ABSTRACT

Embodiments of the present disclosure relate to HARQ-ACK codebook determination. According to some embodiments of the disclosure, a UE may: receive a first PDSCH scrambled by a first RNTI on one of a plurality of candidate PDSCH reception occasions; and transmit a HARQ-ACK codebook comprising a HARQ-ACK information bit(s) for each candidate PDSCH scrambled by the first RNTI within the plurality of candidate PDSCH reception occasions and a HARQ-ACK information bit(s) for each candidate PDSCH scrambled by a second RNTI within the plurality of candidate PDSCH reception occasions.

### TECHNICAL FIELD

Embodiments of the present disclosure generally relate to wireless communication technology, and more particularly to hybrid automatic repeat request acknowledgement (HARQ-ACK) codebook determination.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, a user equipment (UE) may monitor a physical downlink control channel (PDCCH) in one or more search spaces. The PDCCH may carry downlink control information (DCI), which may schedule uplink channels, such as a physical uplink shared channel (PUSCH), or downlink channels, such as a physical downlink shared channel (PDSCH). In the case that a DCI schedules a PDSCH, the UE may transmit hybrid automatic repeat request acknowledgement (HARQ-ACK) feedback (e.g., HARQ-ACK information bit(s)) for the PDSCH through a PUSCH or a physical uplink control channel (PUCCH). For example, the PUCCH may carry a HARQ-ACK codebook including the HARQ-ACK feedback information bit(s) for the PDSCH.

The industry desires technologies for facilitating HARQ-ACK codebook determination in a communication system.

### SUMMARY

Some embodiments of the present disclosure provide a user equipment (UE). The UE may include: a transceiver; and a processor coupled to the transceiver. The processor may be configured to: receive a first physical downlink shared channel (PDSCH) scrambled by a first radio network temporary identifier (RNTI) on one of a plurality of candidate PDSCH reception occasions, wherein the first RNTI is common to a first group of UEs including the UE; transmit a hybrid automatic repeat request acknowledgement (HARQ-ACK) codebook comprising a HARQ-ACK information bit(s) for each candidate PDSCH scrambled by the first RNTI within the plurality of candidate PDSCH reception occasions and a HARQ-ACK information bit(s) for each candidate PDSCH scrambled by a second RNTI within the plurality of candidate PDSCH reception occasions, wherein the second RNTI is common to a second group of UEs including the UE.

Some embodiments of the present disclosure provide a base station (BS). The BS may include: a transceiver; and a processor coupled to the transceiver. The processor may be configured to: transmit, to a first group of user equipment (UE) including a first UE, a first physical downlink shared channel (PDSCH) scrambled by a first radio network temporary identifier (RNTI) on one of a plurality of candidate PDSCH reception occasions, wherein the first RNTI is common to the first group of UEs; and receive, from the first UE, a hybrid automatic repeat request acknowledgement (HARQ-ACK) codebook comprising a HARQ-ACK information bit(s) for each candidate PDSCH scrambled by the first RNTI within the plurality of candidate PDSCH reception occasions and a HARQ-ACK information bit(s) for each candidate PDSCH scrambled by a second RNTI within the plurality of candidate PDSCH reception occasions, wherein the second RNTI is common to a second group of UEs including the first UE.

Some embodiments of the present disclosure provide a method for wireless communication performed by a user equipment (UE). The method may include: receiving a first physical downlink shared channel (PDSCH) scrambled by a first radio network temporary identifier (RNTI) on one of a plurality of candidate PDSCH reception occasions, wherein the first RNTI is common to a first group of UEs including the UE; transmitting a hybrid automatic repeat request acknowledgement (HARQ-ACK) codebook comprising a HARQ-ACK information bit(s) for each candidate PDSCH scrambled by the first RNTI within the plurality of candidate PDSCH reception occasions and a HARQ-ACK information bit(s) for each candidate PDSCH scrambled by a second RNTI within the plurality of candidate PDSCH reception occasions, wherein the second RNTI is common to a second group of UEs including the UE.

Some embodiments of the present disclosure provide a method for wireless communication performed by a base station (BS). The method may include: transmitting, to a first group of user equipment (UE) including a first UE, a first physical downlink shared channel (PDSCH) scrambled by a first radio network temporary identifier (RNTI) on one of a plurality of candidate PDSCH reception occasions, wherein the first RNTI is common to the first group of UEs; and receiving, from the first UE, a hybrid automatic repeat request acknowledgement (HARQ-ACK) codebook comprising a HARQ-ACK information bit(s) for each candidate PDSCH scrambled by the first RNTI within the plurality of candidate PDSCH reception occasions and a HARQ-ACK information bit(s) for each candidate PDSCH scrambled by a second RNTI within the plurality of candidate PDSCH reception occasions, wherein the second RNTI is common to a second group of UEs including the first UE.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an exemplary time domain resource allocation (TDRA) configuration in accordance with some embodiments of the present disclosure;

FIG. 3 illustrates a schematic diagram of HARQ-ACK codebook determination in accordance with some embodiments of the present disclosure;

FIG. 4 illustrates a flow chart of an exemplary procedure of wireless communications in accordance with some embodiments of the present disclosure;

FIG. 5 illustrates a flow chart of an exemplary procedure of wireless communications in accordance with some embodiments of the present disclosure; and

FIG. 6 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

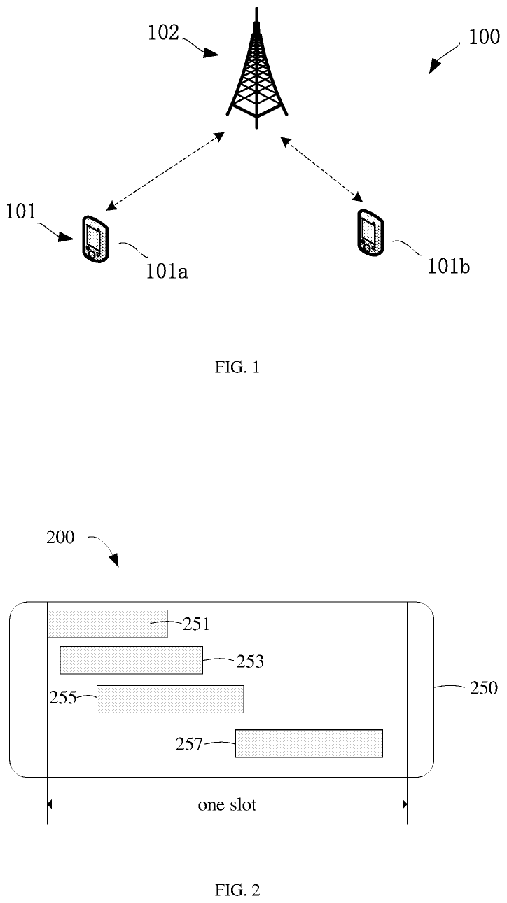

FIG. 1 illustrates a schematic diagram of a wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or in described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

Several types of HARQ-ACK codebooks may be defined for HARQ-ACK multiplexing for multiple received PDSCHs. One may be named a Type-1 HARQ-ACK codebook (also referred to as “semi-static HARQ-ACK codebook”), and another may be named a Type-2 HARQ-ACK codebook (also referred to as “dynamic HARQ-ACK codebook”).

For example, the size of a Type-1 HARQ-ACK codebook (e.g., the number of HARQ-ACK information bits included therein) may be independent of the actual scheduling situation. For instance, the number of HARQ-ACK information bits may be determined based on a list of parameters, including, for example, PDSCH-to-HARQ timing values (also referred to as “HARQ-ACK feedback timing set” or “K1 set”), the configured maximum number of code block groups (CBGs) per transport block (TB), the configured number of component carriers, and/or other(s). The K1 set may be configured to a UE via an RRC signaling message or predefined in a standard(s). For example, the K1 set may be configured by a higher layer parameter, e.g., d1-DataToUL-ACK in PUCCH-config information element (IE).

Both Type-1 HARQ-ACK codebook and Type-2 HARQ-ACK codebook may be supported for UEs receiving a multicast and broadcast service (MBS) (e.g., PDSCHs scrambled by a group-common radio network temporary identifier (RNTI)). The group-common RNTI (e.g., G-RNTI) is introduced for the MBS so that a UE can differentiate a DCI format (hereinafter, “group-common DCI format”) scheduling a PDSCH carrying an MBS service from a DCI format scheduling a UE-specific PDSCH carrying a unicast service.

For example, the cyclic redundancy check (CRC) of the DCI format scheduling the unicast PDSCH may be scrambled by a UE-specific RNTI (e.g., cell-RNTI (C-RNTI)) and the scheduled unicast PDSCH may also be scrambled by the UE-specific RNTI. The CRC of a group-common DCI format may be scrambled by a G-RNTI and the PDSCH scheduled by the group-common DCI format carrying a multicast service may also be scrambled by the G-RNTI. When a UE supports multiple MBS services, each service may be configured with a G-RNTI specific to the service. In other words, from a UE's perspective, the G-RNTIs can be used to differentiate the multiple MBS services.

In some embodiments of the present disclosure, the same HARQ-ACK feedback timing set (may also be referred to as “K1 set”) may be applied to all G-RNTIs (all multicast services) with ACK/NACK based feedback and with the same priority on a given serving cell of a UE. In some embodiments of the present disclosure, the UE may apply a HARQ-ACK feedback timing set separate from the one for the multicast service(s) to a unicast service. For HARQ-ACK feedback transmission in a specific slot, a UE may determine a plurality of candidate PDSCH reception occasions based on the corresponding HARQ-ACK feedback timing set.

Moreover, the candidate PDSCH reception occasion(s) in a scheduled slot may depend on a time domain resource allocation (TDRA) table, which may be configured to a UE via an RRC signaling message or predefined in a standard(s). For example, the TDRA table may be configured by a higher layer parameter, e.g., pdsch-TimeDomainAllocation. In some examples, each entry of the TDRA table may include a start and length indicator value (SLIV) indicating a starting symbol and length of a scheduled transmission (e.g., PDSCH) in a slot. In some embodiments of the present disclosure, the same TDRA table may be applied to all G-RNTIs (all multicast services) if configured on a given serving cell for a UE.

FIG. 2 illustrates an exemplary time domain resource allocation (TDRA) configuration 200 in accordance with some embodiments of the present disclosure. A UE may be configured with a TDRA table 250 for a unicast transmission(s) or a multicast transmission(s), which may include four SLIVs 251-257. As shown in FIG. 2, SLIV 257 does not overlap SLIVs 251 and 253, which is referred to as “two” non-overlapped SLIVs in the context of the disclosure. Accordingly, at most two PDSCHs can be scheduled in a slot according to TDRA table 250. Therefore, the UE may determine that there are two candidate PDSCH reception occasions in a scheduled slot according to TDRA table 250. In some other examples, a TDRA table may merely include SLIVs 251-255, which is referred to as “one” non-overlapped SLIV in the context of the disclosure.

In some embodiments of the present disclosure, a UE may be configured with a Type-1 HARQ-ACK codebook, a plurality of G-RNTIs and a frequency-division multiplexed (FDMed) multicast reception. In some embodiments, a corresponding HARQ-ACK sub-codebook may be generated for each G-RNTI according to the K1 set and TDRA configuration.

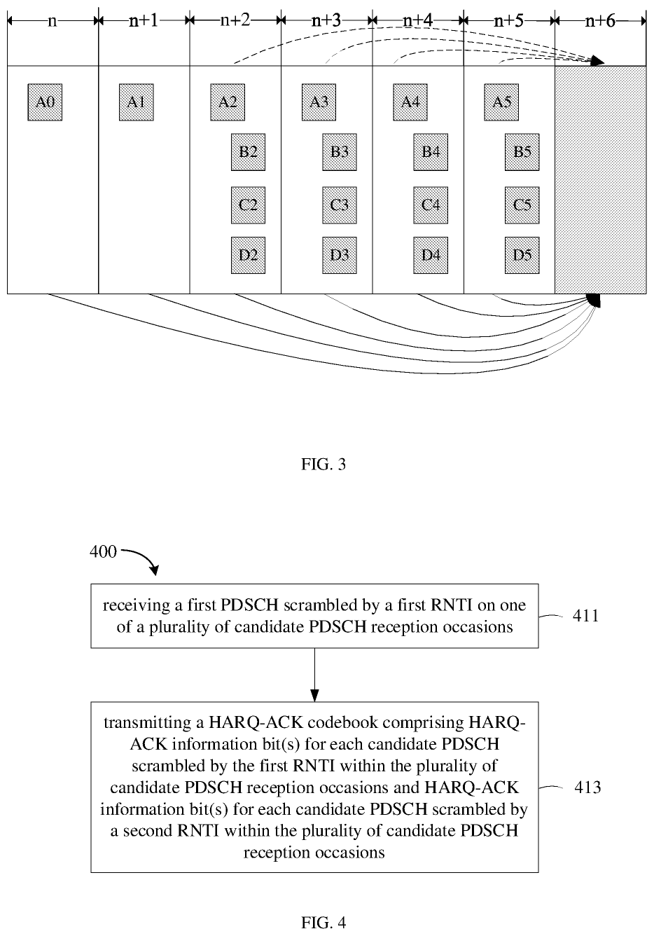

For example, referring to FIG. 3, it is assumed that a UE is configured with a K1 set of {1,2,3,4,5,6} for unicast PDSCH transmissions, a K1 set of {1,2,3,4} for multicast PDSCH transmissions. It is further assumed that the UE is configured with a TDRA table for the unicast PDSCH transmissions with one non-overlapped SLIV and a TDRA table for the multicast PDSCH transmissions with one non-overlapped SLIV.

The UE may be configured with three multicast services (e.g., multicast #B, #C and #D) differentiated by different G-RNTIs. It is further assumed that the value of G-RNTI for multicast #B<the value of G-RNTI for multicast #C<the value of G-RNTI for multicast #D. For HARQ-ACK feedback transmission in slot n+6, the UE may determine six candidate PDSCH reception occasions A0˜A5 for unicast (respectively corresponding to values 6, 5, 4, 3, 2, and 1 in the configured K1 set for unicast), four candidate PDSCH reception occasions B2˜B5 for multicast #B (respectively corresponding to values 4, 3, 2, and 1 in the configured K1 set for multicast), four candidate PDSCH reception occasions C2˜C5 for multicast #C (respectively corresponding to values 4, 3, 2, and 1 in the configured K1 set for multicast), and four candidate PDSCH reception occasions D2˜D5 for multicast #D (respectively corresponding to values 4, 3, 2, and 1 in the configured K1 set for multicast).

For simplicity, it is assumed that a code block group (CBG) based retransmission and a maximum of 2 codewords per PDSCH are not configured. In some embodiments of the present disclosure, as long as one unicast PDSCH is detected among the six candidate PDSCH reception occasions A˜A5, the UE may generate a Type-1 HARQ-ACK codebook {{a0,a1,a2,a3,a4,a5}, {b2,b3,b4,b5}, {c2,c3,c4,c5}, {d2,d3,d4,d5}}, where a0˜a5 are HARQ-ACK information bits corresponding to A0˜A5, b2˜b5 are HARQ-ACK information bits corresponding to B2˜B5, c2˜c5 are HARQ-ACK information bits corresponding to C2˜C5, and d2˜d5 are HARQ-ACK information bits corresponding to D2˜D5. A HARQ-ACK information bit corresponding to a candidate PDSCH reception occasion may be an ACK or a negative ACK (NACK) bit. For example, when a PDSCH is received in a candidate PDSCH reception occasion and is correctly decoded by the UE, an ACK may be generated for this candidate PDSCH reception occasion; when no PDSCH is received in a candidate PDSCH reception occasion or the received PDSCH is incorrectly decoded by the UE, a NACK may be generated for this candidate PDSCH reception occasion. In the above embodiments, too much overhead may be generated.

In some embodiments of the present disclosure, an MBS may support the enabling and disabling of the HARQ-ACK feedback. For example, RRC signaling may be used to configure the presence of a field for indicating the enabling or disabling of the HARQ-ACK feedback (hereinafter, “HARQ-ACK feedback enabling/disabling indicator (HEI)”) in a group-common DCI format for multicast scheduling. The configuration may be configured per a G-RNTI (e.g., per a multicast service corresponding to the G-RNTI). The HEI field may include one bit. Whether the HARQ-ACK feedback for a G-RNTI (or the corresponding multicast service or MBS) is enabled or disabled may be determined based on the HEI field in the group-common DCI with the CRC scrambled by the G-RNTI.

In some embodiments of the present disclosure, the HARQ-ACK feedback enabling/disabling indicator (HEI) may only be included in a certain type of group-common DCI format (e.g., a non-fallback DCI format with at least one field size(s) configurable), and not included in another type(s) of group-common DCI format (e.g., a fallback DCI format with each field size fixed).

The coexistence of a Type-1 HARQ-ACK codebook configuration and HEI configuration may cause an ambiguity for determining the HARQ-ACK feedback. For example, when a UE does not detect any PDSCH in a candidate PDSCH reception occasion for a given G-RNTI, the UE cannot know whether to generate HARQ-ACK feedback for the candidate PDSCH reception occasion. Moreover, since the HEI is not included in, for example, a fallback DCI format with a CRC scrambled by the given G-RNTI, when a UE detects such a DCI format, the UE does not know whether or how to generate the HARQ-ACK information bit(s) for a PDSCH scheduled by the DCI format.

Embodiments of the present disclosure provide solutions for HARQ-ACK codebook determination. For example, solutions for determining a Type-1 HARQ-ACK codebook that can solve the above issued are proposed. For example, solutions for determining a Type-1 HARQ-ACK codebook when a UE is configured with a plurality of G-RNTIs and FDMed multicast reception are proposed. These solutions can solve HARQ-ACK codebook ambiguity and HARQ-ACK codebook misunderstanding between a UE and a BS. More details on the embodiments of the present disclosure will be illustrated in the following text in combination with the appended drawings.

In some embodiments of the present disclosure, a UE may be configured with a maximum number of FDMed PDSCHs in a candidate PDSCH reception occasion by, for example, RRC signaling. In some examples, the maximum number of FDMed PDSCHs in a candidate PDSCH reception occasion may refer to the maximum number of FDMed PDSCHs for at least one multicast service (denoted as “K”) in a candidate PDSCH reception occasion. In some embodiments, 1<=K<=N, wherein N denotes the number of configured G-RNTIs for receiving corresponding multicast services. In some embodiments, as a UE capability, a UE may report the supported maximum number of FDMed multicast PDSCHs in one candidate PDSCH reception occasion to a BS. A UE may not expect to receive more than K multicast PDSCHs in one candidate PDSCH reception occasion.

When a UE is configured with a plurality of multicast services, the HARQ-ACK feedback for all the configured multicast services may be included in a single HARQ-ACK codebook (or sub-codebook). For example, when a UE is configured with FDMed unicast service and a plurality of multicast services, the UE may generate a HARQ-ACK codebook including a sub-codebook (sub-codebook #1) for the unicast services and another sub-codebook (sub-codebook #2) for the plurality of multicast services.

The size of sub-codebook #2 may be determined based on the maximum number of FDMed PDSCHs in a candidate PDSCH reception occasion, the number of non-overlapped SLIVs (denoted as “Y”) in a TDRA table associated with the multicast services, and the number of values (denoted as “X”) in the K1 set associated with the multicast services.

For example, assuming that a CBG-based retransmission and a maximum of 2 codewords per PDSCH are not configured, the UE may determine that the corresponding HARQ-ACK information bits for a given slot (e.g., the size of sub-codebook #2) comprises M=X×K×Y bits. For instance, assuming that the K1 set for the plurality of multicast services is configured as {1,2,3,4}, K is configured as 2, and the TDRA table includes a maximum of 2 non-overlapped SLIVs, then M=4×2×2=16. That is, sub-codebook #2 includes 16 bits, with every 4 (K×Y=4 in this case) consecutive bits for each candidate PDSCH reception slot.

HARQ-ACK information bits in sub-codebook #2 may be generated from a candidate PDSCH reception occasion to another among the plurality of candidate PDSCH reception occasions according to a predefined order (e.g., from the earliest to the latest candidate PDSCH reception occasion in the time domain, or according to a reverse order of the values in the configured K1 set for the multicast services). Within the same candidate PDSCH reception occasion, HARQ-ACK information bits for different multicast services may be ordered according to their associated G-RNTI values (e.g., in an ascending or descending order of the G-RNTI values).

For example, for sub-codebook #2, the UE may order HARQ-ACK information bits for different multicast services according to the values of the corresponding RNTIs for the same candidate PDSCH reception occasion, and concatenated from a first candidate PDSCH occasion till the last within the plurality of candidate PDSCH reception occasions.

For example, referring again to FIG. 3, assuming that the maximum number of FDMed multicast PDSCHs in a candidate PDSCH reception occasion is configured as 2 (i.e., K=2) and the CBG-based retransmission and maximum of 2 codewords per PDSCH are not configured, the UE may generate sub-codebook #1 for unicast as {a0,a1,a2,a3,a4,a5}. The UE may generate sub-codebook #2 as {x2, y2, x3, y3, x4, y4, x5, y5}. In sub-codebook #2, x2 and y2 may be two of b2, c2, and d2 depending on the received multicast PDSCHs for the multicast service #B. #C or #D in slot n+2 and ordered based on the value of associated G-RNTIs; x3 and y3 may be two of b3, c3, and d3 depending on the received multicast PDSCHs for the multicast service #B. #C or #D in slot n+3 and ordered based on the value of associated G-RNTIs; x4 and y4 may be two of b4, c4, and d4 depending on the received multicast PDSCHs for the multicast service #B. #C or #D in slot n+4 and ordered based on the value of associated G-RNTIs; x5 and y5 may be two of b5, c5, and d5 depending on the received multicast PDSCHs for the multicast service #B. #C or #D in slot n+5 and ordered based on the value of associated G-RNTIs.

In some embodiments, the sub-codebook for unicast may be arranged at a predefined position (e.g., placed in front of all sub-codebooks for multicast) of the HARQ-ACK codebook. For example, the UE may generate a Type-1 HARQ-ACK codebook of {{a0,a1,a2,a3,a4,a5}, {x2, y2, x3, y3, x4, y4, x5, y5}}. In this away. HARQ-ACK codebook overhead can be reduced.

In some examples, the maximum number of FDMed PDSCHs in a candidate PDSCH reception occasion may refer to the maximum number of FDMed PDSCHs for at least one multicast service and a PDSCH(s) for at least one unicast service in a candidate PDSCH reception occasion. In these examples, a UE can determine the maximum number of FDMed multicast PDSCHs in a candidate PDSCH reception occasion by subtracting the number of unicast PDSCHs (e.g., 1) in a candidate PDSCH reception occasion from the configured maximum number. Therefore, the above embodiments for determining the HARQ-ACK codebook can be similarly applied.

In some embodiments of the present disclosure, separate sub-codebooks may be generated for different multicast services supported by a UE. Sub-codebooks for a plurality of multicast services supported by a UE may be arranged in a HARQ-ACK codebook according to the G-RNTI values associated with the plurality of multicast services (e.g., in an ascending or descending order of the G-RNTI values).

In some embodiments of the present disclosure, for a multicast service (for clarity, denoting the multicast service and its associated G-RNTI as multicast service #1A and RNTI #1A) among a plurality of multicast services supported by a UE, when a UE does not detect, among a plurality of candidate PDSCH reception occasions, any semi-persistent scheduling (SPS) PDSCH scrambled by RNTI #1A, any PDSCH scheduled by a DCI format with a CRC scrambled by RNTI #1A, any DCI format with a CRC scrambled by RNTI #1A for activating an SPS PDSCH, and any DCI format with a CRC scrambled by RNTI #1A for releasing an SPS PDSCH, the UE may do not generate a sub-codebook for multicast service #1A. To put it another way, the sub-codebook for multicast service #1A may include zero HARQ-ACK information bits.

Otherwise, the UE may determine that a sub-codebook for multicast service #1A comprises M1 HARQ-ACK information bits. M1 may be determined based on the K1 set and TDRA table for the multicast service(s). For example, assuming that the corresponding K1 set includes X values and the TDRA table includes maximum Y non-overlapped SLIVs, then M1=X×Y. For example, assuming that the K1 set for the multicast services is configured as {1,2,3,4}, and the TDRA table includes a maximum of 2 non-overlapped SLIVs, then M1=4×2=8. That is, the sub-codebook for multicast service #1A may include 8 bits, with every 2 (Y=2 in this case) consecutive bits for each candidate PDSCH reception slot.

In this way, when a UE is configured with unicast service and a plurality of multicast services, a maximum of N+1 HARQ-ACK sub-codebooks may be generated when multiplexing HARQ-ACK feedback for the unicast and the plurality of multicast services in one HARQ-ACK codebook. N may denote the number of configured G-RNTIs for receiving the plurality of multicast services. The sub-codebook for the unicast service may be arranged at a predefined position (e.g., placed in front of all sub-codebooks for multicast) of the HARQ-ACK codebook.

For example, referring again to FIG. 3, assuming that N=3 and the TDRA table for the multicast services includes a maximum of 1 non-overlapped SLIVs, and the CBG-based retransmission and maximum of 2 codewords per PDSCH are not configured, when, in candidate PDSCH reception occasions C2˜C5 for multicast #C (denoting its associated RNTI as RNTI #C), a UE does not detect any SPS PDSCH scrambled by RNTI #C, any PDSCH scheduled by a DCI format with a CRC scrambled by RNTI #C, any DCI format scrambled by RNTI #C for activating an SPS PDSCH, and any DCI format scrambled by RNTI #C for releasing an SPS PDSCH, the HARQ-ACK sub-codebook for multicast #C (or RNTI #C) is null. The Type-1 HARQ-ACK codebook may be represented as {{a0,a1,a2,a3,a4,a5}, {b2,b3,b4,b5}, {d2,d3,d4,d5}}.

Otherwise, when the UE detect any of the following: an SPS PDSCH scrambled by RNTI #C, a PDSCH scheduled by a DCI format with a CRC scrambled by RNTI #C, a DCI format scrambled by RNTI #C for activating an SPS PDSCH, or a DCI format scrambled by RNTI #C for releasing an SPS PDSCH, the Type-1 HARQ-ACK codebook may be represented as {{a0,a1,a2,a3,a4,a5}, {b2,b3,b4,b5}, {c2,c3,c4,c5}, {d2,d3,d4,d5}}.

In some embodiments of the present disclosure, for a multicast service (for clarity, denoting the multicast service and its associated G-RNTI as multicast service #1B and RNTI #1B) among a plurality of multicast services supported by a UE, when a UE detects, among a plurality of candidate PDSCH reception occasions, only an SPS PDSCH scrambled by RNTI #1B, a PDSCH scheduled by a DCI format with a CRC scrambled by RNTI #1B, a single DCI format with a CRC scrambled by RNTI #1B for activating an SPS PDSCH, or a single DCI format with a CRC scrambled by RNTI #1B for releasing an SPS PDSCH, the UE may generate a sub-codebook for multicast service #1B, which includes only a HARQ-ACK information bit(s) for the SPS PDSCH scrambled by RNTI #1B, the PDSCH scheduled by the DCI format with a CRC scrambled by RNTI #1B, the single DCI format for activating an SPS PDSCH, or the single DCI format for releasing an SPS PDSCH. In some examples, the value of the DAI of the single DCI format may be set as a predefined value (e.g., 1). For example, when the CBG-based retransmission and maximum of 2 codewords per PDSCH are not configured, the sub-codebook for multicast service #1B may include 1 bit.

Otherwise, the UE may determine that a sub-codebook for multicast service #1B comprises M2 HARQ-ACK information bits. M2 may be determined based on the K1 set and TDRA table for the multicast service(s). For example, assuming that the corresponding K1 set includes X values and the TDRA table includes maximum Y non-overlapped SLIVs, then M2=X×Y. For example, assuming that the K1 set for the multicast services is configured as {1,2,3,4}, and the TDRA table includes a maximum of 2 non-overlapped SLIVs, then M2=4×2=8. That is, the sub-codebook for multicast service #1B may include 8 bits, with every 2 (Y=2 in this case) consecutive bits for each candidate PDSCH reception slot.

In this way, when a UE is configured with unicast service and a plurality of multicast services, N+1 HARQ-ACK sub-codebooks may be generated when multiplexing HARQ-ACK feedback for the unicast and the plurality of multicast services in one HARQ-ACK codebook. N may denote the number of configured G-RNTIs for receiving the plurality of multicast services. The sub-codebook for the unicast service may be arranged at a predefined position (e.g., placed in front of all sub-codebooks for multicast) of the HARQ-ACK codebook.

For example, referring again to FIG. 3, assuming that N=3 and the TDRA table for the multicast services includes a maximum of 1 non-overlapped SLIVs, and the CBG-based retransmission and maximum of 2 codewords per PDSCH are not configured, when, in candidate PDSCH reception occasions C2˜C5 for multicast #C (denoting its associated RNTI as RNTI #C), a UE detects only an SPS PDSCH scrambled by RNTI #C, or only a PDSCH scheduled by a DCI format with a CRC scrambled by RNTI #C, or only a DCI format scrambled by RNTI #C for activating an SPS PDSCH, or only a DCI format scrambled by RNTI #C for releasing an SPS PDSCH, the HARQ-ACK sub-codebook for multicast #C (or RNTI #C) may include one bit (denoted as “c”). The Type-1 HARQ-ACK codebook may be represented as {{a0,a1,a2,a3,a4,a5}, {b2,b3,b4,b5}, {c}, {d2,d3,d4,d5}}. Otherwise, the Type-1 HARQ-ACK codebook may be represented as {{a0,a1,a2,a3,a4,a5}, {b2,b3,b4,b5}, {c2,c3,c4,c5}, {d2,d3,d4,d5}}.

In some embodiments, the DCI format scheduling the detected PDSCH and the DCI format for activating or releasing an SPS PDSCH may be a DCI format (e.g., a fallback DCI format) for a multicast service that always does not include the HEI. In some embodiments, the DCI format scheduling the detected PDSCH and the DCI format for activating or releasing an SPS PDSCH may be a DCI format (e.g., a non-fallback DCI format) for a multicast service that includes the HEI when configured.

In some embodiments of the present disclosure, when an HEI is configured to be presented in a DCI format, during the determination of a Type-1 HARQ-ACK codebook, each candidate PDSCH reception occasion may be mapped to a HARQ-ACK information bit(s). For example, when a DCI format is detected, the corresponding HARQ-ACK information bit(s) may be generated for the scheduled PDSCH regardless of whether the HARQ-ACK feedback is enabled or disabled. When the DCI format is not detected, a NACK bit(s) may be generated. To put it another way, regardless of whether the presence of an HEI is configured in a DCI format for scheduling a PDSCH, a UE may always generate a HARQ-ACK information bit(s) for the scheduled PDSCH.

Alternatively, a UE may not expect to be configured with Type-1 HARQ-ACK codebook and the presence of an HEI in a DCI format. For example, a BS may not configure the UE of the presence of an HEI in a DCI format and a Type-1 HARQ-ACK codebook.

In this way, the ambiguity caused by the coexistence of a Type-1 HARQ-ACK codebook configuration and HEI configuration can be avoided. The same understanding between a UE and a BS can be guaranteed.

FIG. 4 illustrates a flow chart of an exemplary procedure 400 for wireless communications in accordance with some embodiments of the present disclosure. Details described in all of the foregoing embodiments of the present disclosure are applicable for the embodiments shown in FIG. 4. In some examples, the procedure may be performed by a UE, for example, UE 101 in FIG. 1.

Referring to FIG. 4, in operation 411, a UE may receive a first PDSCH scrambled by a first RNTI on one of a plurality of candidate PDSCH reception occasions. The first RNTI may be common to a first group of UEs including the UE.

In operation 413, the UE may transmit a HARQ-ACK codebook comprising a HARQ-ACK information bit(s) for each candidate PDSCH scrambled by the first RNTI within the plurality of candidate PDSCH reception occasions and a HARQ-ACK information bit(s) for each candidate PDSCH scrambled by a second RNTI within the plurality of candidate PDSCH reception occasions. The second RNTI may be common to a second group of UEs including the UE.

In some embodiments of the present disclosure, the UE may receive a signaling message indicating a maximum number of FDMed PDSCHs in a candidate PDSCH reception occasion of the plurality of candidate PDSCH reception occasions. In some examples, the FDMed PDSCHs may include a PDSCH(s) for at least one multicast service. In some examples, the FDMed PDSCHs may include a PDSCH(s) for at least one multicast service and a PDSCH(s) for at least one unicast service.

In some examples, the size of the HARQ-ACK codebook may be determined based on the maximum number of FDMed PDSCHs, the number of non-overlapped SLIVs in a TDRA table associated with the first RNTI and the second RNTI, and the number of values in a set of HARQ-ACK feedback timing values associated with the first RNTI and the second RNTI.

In some examples, the HARQ-ACK information bit(s) for each candidate PDSCH scrambled by the first RNTI within the plurality of candidate PDSCH reception occasions and the HARQ-ACK information bit(s) for each candidate PDSCH scrambled by the second RNTI within the plurality of candidate PDSCH reception occasions may be ordered in the HARQ-ACK codebook according to the values of the first RNTI and second RNTI for the same candidate PDSCH reception occasion and may be concatenated from a first candidate PDSCH occasion till the last within the plurality of candidate PDSCH reception occasions.

In some embodiments of the present disclosure, the HARQ-ACK codebook may include a first sub-codebook including the HARQ-ACK information bit(s) for each candidate PDSCH scrambled by the first RNTI within the plurality of candidate PDSCH reception occasions and a second sub-codebook including the HARQ-ACK information bit(s) for each candidate PDSCH scrambled by the second RNTI within the plurality of candidate PDSCH reception occasions. The first sub-codebook and the second sub-codebook may be arranged according to the values of the first RNTI and second RNTI.

In some embodiments of the present disclosure, the UE may determine that the second sub-codebook includes zero bits in response to detecting, among the plurality of candidate PDSCH reception occasions, no SPS PDSCH scrambled by the second RNTI, no PDSCH scheduled by a DCI format with a CRC scrambled by the second RNTI, no DCI format with a CRC scrambled by the second RNTI for activating an SPS PDSCH, and no DCI format with a CRC scrambled by the second RNTI for releasing an SPS PDSCH. In some embodiments of the present disclosure, the UE may in response to detecting, among the plurality of candidate PDSCH reception occasions, only a SPS PDSCH scrambled by the second RNTI, a PDSCH scheduled by a DCI format with a CRC scrambled by the second RNTI, a single DCI format with a CRC scrambled by the second RNTI for activating an SPS PDSCH, or a single DCI format with a CRC scrambled by the second RNTI for releasing an SPS PDSCH, determine that the second sub-codebook includes only a HARQ-ACK information bit(s) for the SPS PDSCH scrambled by the second RNTI, the PDSCH scheduled by the DCI format with a CRC scrambled by the second RNTI, the single DCI format for activating an SPS PDSCH, or the single DCI format for releasing an SPS PDSCH. The above-mentioned DCI formats (e.g., the DCI format scheduling the PDSCH, the single DCI format for activating or releasing an SPS PDSCH) may be a fallback DCI format or a non-fallback DCI format.

In some embodiments of the present disclosure, the UE may generate HARQ-ACK information bits for the first PDSCH regardless of whether the presence of an HEI is configured in a DCI format for scheduling the first PDSCH.

In some embodiments of the present disclosure, the UE may further receive a plurality of PDSCHs scrambled by a third RNTI with corresponding HARQ-ACK information bits to be multiplexed in the HARQ-ACK codebook, wherein the third RNTI is specific to the UE. The HARQ-ACK codebook may further include a sub-codebook for the third plurality of PDSCHs which is arranged at a predefined position of the HARQ-ACK codebook.

It should be appreciated by persons skilled in the art that the sequence of the operations in exemplary procedure 400 may be changed and some of the operations in exemplary procedure 400 may be eliminated or modified, without departing from the spirit and scope of the disclosure.

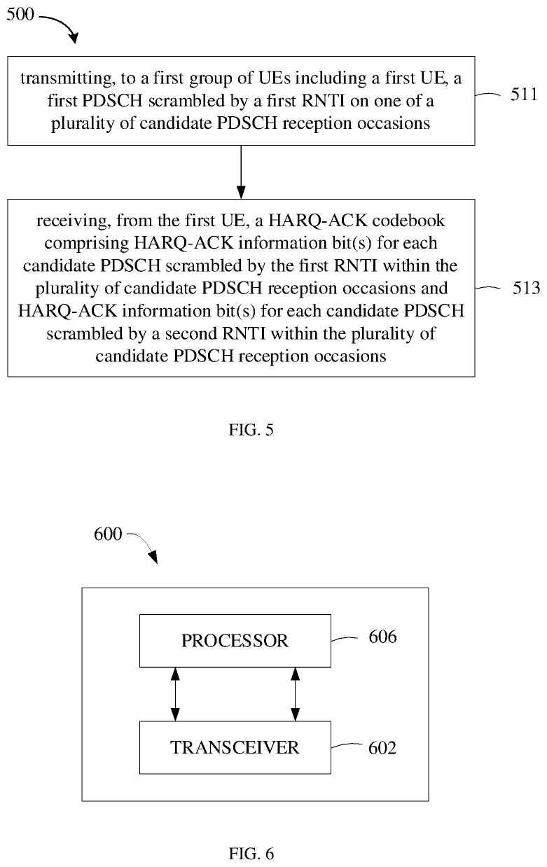

FIG. 5 illustrates a flow chart of an exemplary procedure 500 for wireless communications in accordance with some embodiments of the present disclosure. Details described in all of the foregoing embodiments of the present disclosure are applicable for the embodiments shown in FIG. 5. In some examples, the procedure may be performed by a BS, for example, BS 102 in FIG. 1.

Referring to FIG. 5, in operation 511, a BS may transmit, to a first group of UEs including a first UE, a first PDSCH scrambled by a first RNTI on one of a plurality of candidate PDSCH reception occasions. The first RNTI may be common to the first group of UEs.

In operation 513, the BS may receive, from the first UE, a HARQ-ACK codebook comprising a HARQ-ACK information bit(s) for each candidate PDSCH scrambled by the first RNTI within the plurality of candidate PDSCH reception occasions and a HARQ-ACK information bit(s) for each candidate PDSCH scrambled by a second RNTI within the plurality of candidate PDSCH reception occasions. The second RNTI may be common to a second group of UEs including the first UE.

In some embodiments of the present disclosure, the BS may transmit, to the first UE, a signaling message indicating a maximum number of FDMed PDSCHs in a candidate PDSCH reception occasion of the plurality of candidate PDSCH reception occasions. In some examples, the FDMed PDSCHs may include a PDSCH(s) for at least one multicast service. In some examples, the FDMed PDSCHs may include a PDSCH(s) for at least one multicast service and a PDSCH(s) for at least one unicast service.

In some examples, the size of the HARQ-ACK codebook may be determined based on the maximum number of FDMed PDSCHs, the number of non-overlapped SLIVs in a TDRA table associated with the first RNTI and the second RNTI, and the number of values in a set of HARQ-ACK feedback timing values associated with the first RNTI and the second RNTI.

In some examples, the HARQ-ACK information bit(s) for each candidate PDSCH scrambled by the first RNTI within the plurality of candidate PDSCH reception occasions and the HARQ-ACK information bit(s) for each candidate PDSCH scrambled by the second RNTI within the plurality of candidate PDSCH reception occasions may be ordered in the HARQ-ACK codebook according to the values of the first RNTI and second RNTI for the same candidate PDSCH reception occasion and may be concatenated from a first candidate PDSCH occasion till the last within the plurality of candidate PDSCH reception occasions.

In some embodiments of the present disclosure, the HARQ-ACK codebook may include a first sub-codebook including the HARQ-ACK information bit(s) for each candidate PDSCH scrambled by the first RNTI within the plurality of candidate PDSCH reception occasions and a second sub-codebook including the HARQ-ACK information bit(s) for each candidate PDSCH scrambled by the second RNTI within the plurality of candidate PDSCH reception occasions. The first sub-codebook and the second sub-codebook may be arranged according to the values of the first RNTI and second RNTI.

In some embodiments of the present disclosure, in response to, among the plurality of candidate PDSCH reception occasions, no SPS PDSCH scrambled by the second RNTI, no PDSCH scheduled by a DCI format with a CRC scrambled by the second RNTI, no DCI format with a CRC scrambled by the second RNTI for activating an SPS PDSCH, and no DCI format with a CRC scrambled by the second RNTI for releasing an SPS PDSCH is transmitted, the second sub-codebook may include zero bits. In some embodiments of the present disclosure, in response to, among the plurality of candidate PDSCH reception occasions, only a SPS PDSCH scrambled by the second RNTI, a PDSCH scheduled by a DCI format with a CRC scrambled by the second RNTI, a single DCI format with a CRC scrambled by the second RNTI for activating an SPS PDSCH, or a single DCI format with a CRC scrambled by the second RNTI for releasing an SPS PDSCH is transmitted, the second sub-codebook may include only a HARQ-ACK information bit(s) for the SPS PDSCH scrambled by the second RNTI, the PDSCH scheduled by the DCI format with a CRC scrambled by the second RNTI, the single DCI format for activating an SPS PDSCH, or the single DCI format for releasing an SPS PDSCH. The above-mentioned DCI formats (e.g., the DCI format scheduling the PDSCH, the single DCI format for activating or releasing an SPS PDSCH) may be a fallback DCI format or a non-fallback DCI format.

In some embodiments of the present disclosure, the BS may prohibit configuring the first UE of the presence of an HEI in a DCI format for scheduling the first PDSCH and a semi-static HARQ-ACK codebook.

In some embodiments of the present disclosure, the BS may transmit a signaling message indicating the presence of an HEI in a DCI format for scheduling the first PDSCH. In some examples, the DCI format for scheduling the first PDSCH may indicate a disabled HEI (or disabled HARQ-ACK feedback). However, the first UE may ignore the disabled HEI in the DCI format and may still transmit the HARQ-ACK feedback for the first PDSCH.

It should be appreciated by persons skilled in the art that the sequence of the operations in exemplary procedure 500 may be changed and some of the operations in exemplary procedure 500 may be eliminated or modified, without departing from the spirit and scope of the disclosure.

FIG. 6 illustrates a block diagram of an exemplary apparatus 600 according to some embodiments of the present disclosure. As shown in FIG. 6, the apparatus 600 may include at least one processor 606 and at least one transceiver 602 coupled to the processor 606. The apparatus 600 may be a UE or a BS.

Although in this figure, elements such as the at least one transceiver 602 and processor 606 are described in the singular, the plural is contemplated unless a limitation to the singular is explicitly stated. In some embodiments of the present application, the transceiver 602 may be divided into two devices, such as a receiving circuitry and a transmitting circuitry. In some embodiments of the present application, the apparatus 600 may further include an input device, a memory, and/or other components.

In some embodiments of the present application, the apparatus 600 may be a UE. The transceiver 602 and the processor 606 may interact with each other so as to perform the operations with respect to the UE described in FIGS. 1-5. In some embodiments of the present application, the apparatus 600 may be a BS. The transceiver 602 and the processor 606 may interact with each other so as to perform the operations with respect to the BS described in FIGS. 1-5.

In some embodiments of the present application, the apparatus 600 may further include at least one non-transitory computer-readable medium.

For example, in some embodiments of the present disclosure, the non-transitory computer-readable medium may have stored thereon computer-executable instructions to cause the processor 606 to implement the method with respect to the UE as described above. For example, the computer-executable instructions, when executed, cause the processor 606 interacting with transceiver 602 to perform the operations with respect to the UE described in FIGS. 1-5.

In some embodiments of the present disclosure, the non-transitory computer-readable medium may have stored thereon computer-executable instructions to cause the processor 606 to implement the method with respect to the BS as described above. For example, the computer-executable instructions, when executed, cause the processor 606 interacting with transceiver 602 to perform the operations with respect to the BS described in FIGS. 1-5.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
receive a first physical downlink shared channel (PDSCH) scrambled by a first radio network temporary identifier (RNTI) on one of a plurality of candidate PDSCH reception occasions, wherein the first RNTI is common to a first group of UEs including the UE;
transmit a hybrid automatic repeat request acknowledgement (HARQ-ACK) codebook comprising a HARQ-ACK information bit(s) for each candidate PDSCH scrambled by the first RNTI within the plurality of candidate PDSCH reception occasions and a HARQ-ACK information bit(s) for each candidate PDSCH scrambled by a second RNTI within the plurality of candidate PDSCH reception occasions, wherein the second RNTI is common to a second group of UEs including the UE.

2. The UE of claim 1, wherein the at least one processor is configured to cause the UE to receive a signaling message indicating a maximum number of frequency-division multiplexed (FDMed) PDSCHs in a candidate PDSCH reception occasion of the plurality of candidate PDSCH reception occasions; and
wherein the FDMed PDSCHs comprise a PDSCH(s) for at least one multicast service or comprise a PDSCH(s) for at least one multicast service and a PDSCH(s) for at least one unicast service.

3. The UE of claim 2, wherein a size of the HARQ-ACK codebook is determined based on the maximum number of FDMed PDSCHs, the number of non-overlapped start and length indicator values (SLIVs) in a time domain resource allocation (TDRA) table associated with the first RNTI and the second RNTI, and the number of values in a set of HARQ-ACK feedback timing values associated with the first RNTI and the second RNTI.

4. The UE of claim 2, wherein the HARQ-ACK information bit(s) for each candidate PDSCH scrambled by the first RNTI within the plurality of candidate PDSCH reception occasions and the HARQ-ACK information bit(s) for each candidate PDSCH scrambled by the second RNTI within the plurality of candidate PDSCH reception occasions are ordered in the HARQ-ACK codebook according to values of the first RNTI and second RNTI for the same candidate PDSCH reception occasion and concatenated from a first candidate PDSCH occasion till the last within the plurality of candidate PDSCH reception occasions.

5. The UE of claim 1, wherein the HARQ-ACK codebook comprises a first sub-codebook including the HARQ-ACK information bit(s) for each candidate PDSCH scrambled by the first RNTI within the plurality of candidate PDSCH reception occasions and a second sub-codebook including the HARQ-ACK information bit(s) for each candidate PDSCH scrambled by the second RNTI within the plurality of candidate PDSCH reception occasions, wherein the first sub-codebook and the second sub-codebook are arranged according to values of the first RNTI and second RNTI.

6. The UE of claim 5, wherein the at least one processor is configured to cause the UE to determine that the second sub-codebook comprises zero bits in response to detecting, among the plurality of candidate PDSCH reception occasions, no semi-persistent scheduling (SPS) PDSCH scrambled by the second RNTI, no PDSCH scheduled by a downlink control information (DCI) format with a cyclic redundancy check (CRC) scrambled by the second RNTI, no DCI format with a CRC scrambled by the second RNTI for activating an SPS PDSCH, and no DCI format with a CRC scrambled by the second RNTI for releasing an SPS PDSCH.

7. The UE of claim 5, wherein the at least one processor is configured to cause the UE to, in response to detecting, among the plurality of candidate PDSCH reception occasions, only a semi-persistent scheduling (SPS) PDSCH scrambled by the second RNTI, a PDSCH scheduled by a downlink control information (DCI) format with a cyclic redundancy check (CRC) scrambled by the second RNTI, a single DCI format with a CRC scrambled by the second RNTI for activating an SPS PDSCH, or a single DCI format with a CRC scrambled by the second RNTI for releasing an SPS PDSCH, determine that the second sub-codebook comprises only a HARQ-ACK information bit(s) for the SPS PDSCH scrambled by the second RNTI, the PDSCH scheduled by the DCI format with a CRC scrambled by the second RNTI, the single DCI format for activating an SPS PDSCH, or the single DCI format for releasing an SPS PDSCH.

8. The UE of claim 6, wherein the DCI format and a single DCI format are a fallback DCI format or a non-fallback DCI format.

9. The UE of claim 1, wherein the at least one processor is configured to cause the UE to generate HARQ-ACK information bits for the first PDSCH regardless of whether a presence of a HARQ-ACK feedback enabling/disabling indicator (HEI) is configured in downlink control information (DCI) format for scheduling the first PDSCH.

10. The UE of claim 1, wherein the at least one processor is configured to cause the UE to receive a plurality of PDSCHs scrambled by a third RNTI with corresponding HARQ-ACK information bits to be multiplexed in the HARQ-ACK codebook, wherein the third RNTI is specific to the UE; and
wherein the HARQ-ACK codebook further comprises a sub-codebook for the third plurality of PDSCHs which is arranged at a predefined position of the HARQ-ACK codebook.

11. A base station (BS), comprising:
at least one memory; and
at least one processor coupled with the at least one memory and configured to cause the base station to:
transmit, to a first group of user equipment (UE) including a first UE, a first physical downlink shared channel (PDSCH) scrambled by a first radio network temporary identifier (RNTI) on one of a plurality of candidate PDSCH reception occasions, wherein the first RNTI is common to the first group of UEs; and
receive, from the first UE, a hybrid automatic repeat request acknowledgement (HARQ-ACK) codebook comprising a HARQ-ACK information bit(s) for each candidate PDSCH scrambled by the first RNTI within the plurality of candidate PDSCH reception occasions and a HARQ-ACK information bit(s) for each candidate PDSCH scrambled by a second RNTI within the plurality of candidate PDSCH reception occasions, wherein the second RNTI is common to a second group of UEs including the first UE.

12. The BS of claim 11, wherein the at least one processor is configured to cause the BS to transmit, to the first UE, a signaling message indicating a maximum number of frequency-division multiplexed (FDMed) PDSCHs in a candidate PDSCH reception occasion of the plurality of candidate PDSCH reception occasions; and
wherein the FDMed PDSCHs comprise PDSCHs for at least one multicast service or comprise a PDSCH(s) for at least one multicast service and a PDSCH(s) for at least one unicast service.

13. The BS of claim 12, wherein a size of the HARQ-ACK codebook is determined based on the maximum number of FDMed PDSCHs, the number of non-overlapped start and length indicator values (SLIVs) in a time domain resource allocation (TDRA) table associated with the first RNTI and the second RNTI, and the number of values in a set of HARQ-ACK feedback timing values associated with the first RNTI and the second RNTI.

14. The BS of claim 12, wherein the HARQ-ACK information bit(s) for each candidate PDSCH scrambled by the first RNTI within the plurality of candidate PDSCH reception occasions and the HARQ-ACK information bit(s) for each candidate PDSCH scrambled by the second RNTI within the plurality of candidate PDSCH reception occasions are ordered in the HARQ-ACK codebook according to values of the first RNTI and second RNTI for the same candidate PDSCH reception occasion and concatenated from a first candidate PDSCH occasion till the last within the plurality of candidate PDSCH reception occasions.

15. A method performed by a user equipment (UE), the method comprising:
receiving a first physical downlink shared channel (PDSCH) scrambled by a first radio network temporary identifier (RNTI) on one of a plurality of candidate PDSCH reception occasions, wherein the first RNTI is common to a first group of UEs including the UE; and
transmitting a hybrid automatic repeat request acknowledgement (HARQ-ACK) codebook comprising a HARQ-ACK information bit(s) for each candidate PDSCH scrambled by the first RNTI within the plurality of candidate PDSCH reception occasions and a HARQ-ACK information bit(s) for each candidate PDSCH scrambled by a second RNTI within the plurality of candidate PDSCH reception occasions, wherein the second RNTI is common to a second group of UEs including the UE.

16. A processor for wireless communication, comprising:
at least one controller coupled with at least one memory and configured to cause the processor to:
receive a first physical downlink shared channel (PDSCH) scrambled by a first radio network temporary identifier (RNTI) on one of a plurality of candidate PDSCH reception occasions, wherein the first RNTI is common to a first group of user equipments (UEs) including the processor;
transmit a hybrid automatic repeat request acknowledgement (HARQ-ACK) codebook comprising a HARQ-ACK information bit(s) for each candidate PDSCH scrambled by the first RNTI within the plurality of candidate PDSCH reception occasions and a HARQ-ACK information bit(s) for each candidate PDSCH scrambled by a second RNTI within the plurality of candidate PDSCH reception occasions, wherein the second RNTI is common to a second group of UEs including the UE.

17. The processor of claim 16, wherein the at least one controller is configured to cause the UE to receive a signaling message indicating a maximum number of frequency-division multiplexed (FDMed) PDSCHs in a candidate PDSCH reception occasion of the plurality of candidate PDSCH reception occasions; and
wherein the FDMed PDSCHs comprise a PDSCH(s) for at least one multicast service or comprise a PDSCH(s) for at least one multicast service and a PDSCH(s) for at least one unicast service.

18. The processor of claim 17, wherein a size of the HARQ-ACK codebook is determined based on the maximum number of FDMed PDSCHs, the number of non-overlapped start and length indicator values (SLIVs) in a time domain resource allocation (TDRA) table associated with the first RNTI and the second RNTI, and the number of values in a set of HARQ-ACK feedback timing values associated with the first RNTI and the second RNTI.

19. The processor of claim 17, wherein the HARQ-ACK information bit(s) for each candidate PDSCH scrambled by the first RNTI within the plurality of candidate PDSCH reception occasions and the HARQ-ACK information bit(s) for each candidate PDSCH scrambled by the second RNTI within the plurality of candidate PDSCH reception occasions are ordered in the HARQ-ACK codebook according to values of the first RNTI and second RNTI for the same candidate PDSCH reception occasion and concatenated from a first candidate PDSCH occasion till the last within the plurality of candidate PDSCH reception occasions.

20. The processor of claim 16, wherein the HARQ-ACK codebook comprises a first sub-codebook including the HARQ-ACK information bit(s) for each candidate PDSCH scrambled by the first RNTI within the plurality of candidate PDSCH reception occasions and a second sub-codebook including the HARQ-ACK information bit(s) for each candidate PDSCH scrambled by the second RNTI within the plurality of candidate PDSCH reception occasions, wherein the first sub-codebook and the second sub-codebook are arranged according to values of the first RNTI and second RNTI.
